(19) United States
(12) Patent Application Publication
(10) Pub. No.: US 2017/0114305 A1
(43) Pub. Date: Apr. 27, 2017

(54) NOVEL WASHING METHOD WITH ELECTROCHEMICALLY ACTIVATABLE MEDIATOR COMPOUND

(71) Applicant: Henkel AG & Co. KGaA, Duesseldorf (DE)

(72) Inventors: Iwona Spill, Berlin (DE); Peter Schmiedel, Duesseldorf (DE); Mareile Job, Leverkusen (DE); Nicole Bode, Duesseldorf (DE); Christian Nitsch, Duesseldorf (DE); Arnd Kessler, Monheim am Rhein (DE); Thorsten Bastigkeit, Wuppertal (DE); Thomas Mueller-Kirschbaum, Solingen (DE); Thomas Gerke, Duesseldorf (DE); Guido Grundmeier, Wuerzburg (DE); Markus Voigt, Paderborn (DE)

(73) Assignee: Henkel AG & Co. KGaA, Duesseldorf (DE)

(21) Appl. No.: 15/400,804

(22) Filed: Jan. 6, 2017

Related U.S. Application Data
(63) Continuation of application No. PCT/EP2015/065621, filed on Jul. 8, 2015.

(30) Foreign Application Priority Data
Jul. 9, 2014 (DE) 10 2014 213 311.4

(51) Int. Cl. C11D 11/00; C11D 3/37; D06B 5/26; C11D 17/00; D06B 3/10; D06B 5/22; C11D 3/14; C11D 3/39

(52) U.S. Cl. CPC C11D 11/0017; C11D 3/14; C11D 3/3715; C11D 3/3726; C11D 3/3719; C11D 3/392; C11D 11/007; C11D 11/0076; C11D 17/0013; D06B 3/10; D06B 5/22; D06B 5/26

(57) ABSTRACT

The aim of the invention is to improve the cleaning power of washing and cleaning agents, especially with regards to bleachable stains, while avoiding any damage to the textile treated with said washing and cleaning agents. This is achieved by an aqueous washing liquid in a device for cleaning textile substrates, containing a plurality of water in-soluble solid particles and a mediator compound, which can produce an oxidizing bleaching agent, in an electrochemical cell using electric voltage in the washing liquid.

### FIELD OF THE INVENTION

The present invention generally relates to the use of, in particular, organic mediator compounds to increase the cleaning power of washing and cleaning agents with regards to stains, washing and cleaning methods which use bleaching-active species generated from such mediator compounds, and washing and cleaning agents which contain the mediator compound in novel washing methods.

### BACKGROUND OF THE INVENTION

Inorganic peroxy compounds, in particular hydrogen peroxide and solid peroxy compounds, which dissolve in water with release of hydrogen peroxide, such as sodium perborate and sodium carbonate perhydrate, have long been used as oxidizing agents for disinfection and bleaching purposes. The oxidation effect of these substances is heavily dependent in diluted solutions on temperature; for example with H₂O₂ or perborate in alkaline bleaching liquids a sufficiently rapid bleaching of soiled textiles is attained only at temperatures above approximately 80° C. The oxidation effect of the inorganic peroxy compounds can be improved at lower temperatures by the addition of what are known as bleaching activators, which are capable of delivering peroxycarboxylic acids under the specified perhydrolysis conditions and are known in the literature for the numerous proposals, particularly from the substance classes N-acyl and O-acyl compounds, for example reactive esters, multiply acylated alkylene diamines, in particular N,N,N′,N′-tetra acetyl ethylene diamine (TAED), acylated glycolurils, particularly tetra acetyl glycoluril, N-acylated hydantoins, hydrazides, triazoles, hydrotriazines, urazoles diketo piperazine, sulfuryl amides and cyanurates, and in addition carboxylic acid anhydrides, particularly phthalic acid anhydride, carboxylic acid esters, particularly sodium nonanoyloxybenzenesulfonate (NOBS), sodium isononanoyloxybenzenesulfonate, O-acylated sugar derivatives, such as pentaacetylglucose, and N-acylated lactams, such as N-benzoyl caprolactam. Addition of these substances allows the bleaching effect of aqueous peroxide liquids to be intensified to such an extent that even at temperatures around 60° C. substantially the same effects occur as with the peroxide liquid alone at 95° C.

Within the scope of efforts to develop energy-saving washing and bleaching methods, application temperatures well below 60° C., in particular below 45° C. down to cold water temperature have become increasingly significant in recent years.

At these low temperatures, the effect of the previously known activator compounds generally decreases noticeably. There has thus been no lack of efforts to develop activators that are more effective for this temperature range. The use of transition metal compounds, in particular transition metal complexes, in order to increase the oxidation force of peroxy compounds or also atmospheric oxygen in washing and cleaning agents has also been proposed on various occasions. The transition metal compounds proposed for this purpose include, for example, manganese-, iron-, cobalt-, ruthenium- or molybdenum-salen complexes, manganese-, iron-, cobalt-, ruthenium-, or molybdenum-carbonyl complexes, manganese, iron, cobalt, ruthenium, molybdenum, titanium, vanadium and copper complexes with nitrogen-containing tripod ligands, and manganese complexes with polyazacycloalkane ligands, such as TACN. A disadvantage of metal complexes of this type, however, lies in the fact that they either have partly insufficient bleaching power in particular at low temperature, or with sufficient bleaching power there may be undesirable damage to the colors of the material to be washed or to be cleaned and possibly even to the material itself, for example the textile fibers.

It is known from international patent application WO 2013/017476 A1 that bleaching-active species which have a bleach-intensifying effect can be produced from sterically hindered n-hydroxy compounds, such as 1-hydroxy-2,2,6,6-tetramethylpiperidine, by means of electrolysis.

It has surprisingly been found that bleachable stains can also be bleached with use of bleaching-agent-free washing agents, for example in liquid form, when the washing agent contains what is known as a mediator, which is activated by means of an electrochemical cell arranged inside or outside the washing machine, wherein the washing liquid also contains water-insoluble solid particles.

The mediator is an electrochemically activatable bleaching agent precursor. The activated species electrochemically generated from the mediator acts similarly to an oxidizing bleaching agent and can therefore oxidatively decolorize colored ingredients contained in the washing liquid. If the electrochemically generated bleaching-active species is stable in the washing liquid for a sufficiently long period of time, it can pass with the liquid to the dirt disposed on the textile and can deliver the bleaching power there.

The power of both the electrochemical cell arranged inside or outside the machine can be individually controlled via the current intensity and operating time. The bleaching power can thus be adapted to the degree of soiling and the type of textiles treated. If the electrochemical cell is inactive, the mediator does not present any bleaching power. The mediator is thus contained in the washing agent product in inactive form so that it cannot damage sensitive constituents of the washing agent, for example enzymes, dyes and aromatic substances.

Furthermore, other desirable features and characteristics of the present invention will become apparent from the subsequent detailed description of the invention and the appended claims, taken in conjunction with this background of the invention.

### BRIEF SUMMARY OF THE INVENTION

An aqueous washing liquid in a device for cleaning textile substrates, containing a multiplicity of water-insoluble solid particles and a mediator compound or a mixture of two or more mediator compounds, which can produce an oxidizing bleaching agent, in an electrochemical cell using electric voltage in the washing liquid.

Use of a multiplicity of water-insoluble solid particles and of a washing agent containing a mediator compound or a mixture of two or more mediator compounds, which can produce an oxidizing bleaching agent, in an electrochemical cell using electrical voltage in the washing liquid in order to wash soiled textile substrates.

A device for cleaning soiled textile substrates having at least one laundry treatment chamber for receiving substrates, comprising a multiplicity of water-insoluble solid particles, a reservoir for receiving the particles inside or outside the device, and an electrochemical cell consisting of a cathode and an anode, and also a power supply, wherein the area around the anode is connected to the washing liquid in the laundry treatment chamber such that liquid can be exchanged.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The subject of the present invention is, in a first embodiment, an aqueous washing liquid in a device for cleaning textile substrates, containing a multiplicity of water-insoluble solid particles and a mediator compound, which can produce an oxidizing bleaching agent, in an electrochemical cell using electric voltage in the washing liquid. Here, the use of mixtures of two or more mediators is also possible.

The invention relates in particular to the use of mediator compounds which can be activated by means of electrochemical conversion to form bleaching-active species and which can be used to intensify the cleaning power of washing and cleaning agents, here in conjunction with a washing method in which the washing liquid contains water-insoluble solid particles, with regards to stains, in particular bleachable stains, in a preferably liquid washing agent.

The washing method is characterized by the use of a particularly small quantity of water. The intended washing agent can be used particularly advantageously together with the washing method, since high concentrations of active mediator can be easily achieved as a result of the small quantity of water.

The subject of the present invention is therefore also a corresponding method for washing soiled textile substrates using the above-mentioned washing liquid and also a washing machine (device for cleaning soiled textile substrates) having at least one laundry treatment chamber for receiving the substrates, comprising a multiplicity of water-insoluble solid particles, a reservoir for receiving the particles inside or outside the device, and an electrochemical cell consisting of a cathode and an anode and also a power supply, wherein the area around the anode is connected to the washing liquid in the laundry treatment chamber such that liquid can be exchanged.

It is particularly preferred in accordance with the invention when the electrodes contain, in particular consist of, stainless steel and/or graphite. Is very particularly preferred in accordance with the invention when the cathode consists of stainless steel and the anode consists of graphite.

The cathode and anode are preferably, but not necessarily, disposed in separate chambers, which can be separated from one another by a diaphragm or a membrane, wherein the anode chamber is preferably connected to the laundry treatment chamber of the washing machine such that liquid can be exchanged.

The present invention is particularly suitable for use together with or in liquid washing agent, generally free from bleaching agent. The use of mediators provides a solution to the problem, occurring in this case, of the low bleaching power and, if the agent contains bleaching agent after all, the low stability of other ingredients, since the bleaching species is inactive in the product and is only activated in use by an electrochemical reaction.

In order to remove colored constituents disposed in the liquid which have been dissolved out from textile stains or which can originate in particular from washed-out textile dyes, the present invention also comprises the use of mediators, of which the active state is particularly short-lived. It is thus made possible for the mediator to be active only in the direct vicinity of the anode of the electrochemical cell and in this way to bleach only dye dispersed or dissolved in the washing liquid. The electrochemical cell is in this method advantageously arranged in a bypass. If the washing liquid passes from the electrochemical cell back into the laundry treatment chamber of the washing machine, the mediator will have already fully reacted so that it cannot cause any color or fiber damage to the textiles located there. It is possible in this way to free the washing liquid of detached dyes, even in the case of dyes that run, so that textiles of different colors can be washed together.

In respect of this aspect of the invention and in particular in order to destroy washed-out dyes from the textile substrate, the following features are significant:

1. the service life of the active species formed from the mediator should be as short as possible (less than 1 min) so that the risk of discoloration or decolorization of colored textiles is reduced;
2. the mediators should have a high electro-activation rate (activation from non-active to active state with use of the electrochemical method);
3. the mediators should have high efficacy for a wide range of dyes (not selective for a specific number of dyes) or should also comprise a mixture of free radicals/mediators in order to act on different dyes;
4. the mediators should also have a high reactivation rate (the vast majority of the mediator molecules used should be suitable for reactivation at the anode).

For removal of colored stains located on the textile, the present invention also comprises the use of mediators of which the active state is particularly long lasting. It is thus made possible that the activated species created from the mediator is active also at a distance from the anode of the electrochemical cell and, when it encounters a stain on the textile, it delivers its bleaching effect there.

The essential properties of the mediator for use in the removal of bleachable stains located on the textile substrate are as follows:

1. high electro-activity rate (activation from the non-active to the active state by the use of an electrochemical method);
2. good balance of the reactivity (i.e. the reactivity as bleaching agent) with respect to stability;
3. the active species formed from the mediator should be stable for at least 1 min in order to pass from the anode (site of electro-activation) to the soiled textile substrate in the washing drum of the washing machine;
4. a high reactivation rate (the vast majority of the mediator molecules used should be suitable for reactivation at the anode);
5. the mediator should be suitable for a wide range of bleachable stains. Alternatively, a mixture of mediators can also be used for treatment of various stains.

The preferred voltage for the electrochemical cell is 0.2 to 5 V, in particular 1 to 3 V. The service life of the activated species should preferably be 0.1 sec to 120 min and for bleaching applications on textiles should lie in particular in a range of from 3 to 60 min and for the decolorization of dyes in the washing liquid should be in particular <10 sec.

The concentration of the mediator in the liquid proportion of the washing liquid is preferably 0.05 to 10 mmol/1, particularly preferably 0.1 to 2 mmol/L. Here, the liquid proportion of the washing liquid is understood to mean the proportion of the entire washing liquid inclusive of the water-insoluble solid particles which is obtained when the water-insoluble solid particles are separated off from the liquid proportion by centrifuging 8 kg of the washing liquid containing the solid water-insoluble particles for 5 min in a centrifuge with horizontally mounted cylindrical rotating body of 515 mm inner diameter and 370 mm inner depth at 1400 revolutions per minute.

The pH value of the washing liquid can be varied within a wide range. What are particularly preferred are pH values in a range of from 2 to 12, and in particular 4 to 11.

The above-defined method and the device use less water (in relation to textile weight) compared to a conventional washing cycle. Even small amounts of mediator can thus provide an effective concentration and can obtain a good bleaching effect.

A hygienic effect can be obtained even with low activation, without damaging sensitive textiles.

In addition, the active species electrochemically generated from the mediator contained in the washing agent prevents the growth of germs on the water-insoluble particles. The period of use of the particles can thus be increased, which has a positive effect on the carbon footprint of the method.

The activity of the cleaning system can be controlled in a simple manner depending on the fabric and degree of soiling by adjusting the current intensity in the electrochemical cell.

Only a washing agent is also required for bleach-containing and bleach-free applications, and textile substrates of different colors can be washed together, in particular when mediators are used in the washing agent which provide short-lived active species following electro-chemical treatment.

The activity of the bleaching system can be activated at any moment during the washing cycle (for example only at the end). This can have an advantageous effect on the power of other washing agent ingredients, for example enzymes, since these can work initially in a bleach-free environment.

For conventional bleaching systems, an active oxygen carrier and a bleach activator must be formulated. This requires a lot of “space” in the washing agent formulation. In the case of electrochemical bleaches, only the mediator is required in the formulation. The dosing quantity of the washing agent can thus be smaller, and packaging material and transport costs can be saved.

Mediator compounds that can be used are organic compounds which can be electrochemically oxidized or reduced in an aqueous system, preferably in aqueous solution. These compounds are preferably aliphatic, cycloaliphatic, aromatic or araliphatic compounds optionally containing heteroatoms, comprising an N—OH, N—OR group, a nitroxyl radical N—O and/or an N—O⁻group having an M⁺ or ½ M²⁺ counter ion, wherein R is an alkyl group having preferably 1 to 4 C atoms and M is hydrogen, an alkali metal or an alkaline earth metal, which include, for example, hydroxamic acids such as N-hydroxyphthalimide, N-hydroxy heteroaromatics such as 1-hydroxyindole, 1-hydroxybenzimidazole and 1-hydroxybenzotriazole, radicals of sterically hindered N-hydroxy compounds such as (2,2,6,6-tetramethylpiperidin-1-yl)oxyl, and oximidoketones such as violuric acid and N,N′-dimethylvioluric acid, which can be used alone or in mixtures of at least two such compounds. The preferred mediators include 1-hydroxy-2,2,6,6-tetramethylpiperidine, 2,2,6,6-tetramethylpiperidine N-oxide, (2,2,6,6-tetramethylpiperidin-1-yl)ozyl, anionically substituted derivatives thereof, and mixtures thereof.

The anionic substituent in the 2,2,6,6-tetramethylpiperidine derivatives is preferably selected from the SO₃⁻group, the CO₂⁻group, the PO₃²⁻ group, and mixtures thereof. The anionic substituent may be bound to a C atom of the piperidinyl ring directly or preferably via a spacer. A spacer is preferably selected from alkylene groups, aminoalkylene groups, oxyalkylene groups aminocarbonyl alkylene groups, or oxycarbonyl alkylene groups, each having 1 to 25 C atoms, and mixtures thereof. If desired, a molecule can also carry a plurality of anionic substituents; if desired, these can be located at a spacer or at a plurality of spacers. In the anionically substituted 2,2,6,6-tetramethylpiperidine derivative, counter cations, such as hydrogen, alkali metal, alkaline earth metal and/or ammonium ions, are present in a number balancing the negative charge of the anionic group or groups. Preferred 2,2,6,6 tetramethylpiperidine derivatives include those which carry an ester or amide bond at position 4, wherein the anionic substituent is located on the molecule part deriving from the carboxylic acid. These are accessible from 4-hydroxy- or 4-amino-2,2,6,6-tetramethylpiperidine N-oxide or the corresponding hydroxylamine compounds or the corresponding oxyl radicals.

The bleaching-active species can easily be manufactured by subjecting an aqueous system that contains the mediator compound to an electrical potential difference applied between at least two electrodes, which potential difference is preferably 0.2 V to 5 V, in particular 1 V to 3 V, so that the mediator compound gives up an electron. Without wishing to be tied to this theory, it is conceivable that a radical or N-oxoammonium species thereby generated encounters dyes contained in the washing liquid or travels with the aqueous washing liquid to the dirt on the textile and removes an electron from the dye or the stain, with the result that a less-colored and/or more readily water-soluble and/or water-dispersible material is produced. The mediator compound is reconstituted from the bleaching-active species by this reaction, so that a reversible redox system is present. It is possible for the liquid containing the mediator compound to be electrochemically converted continuously or once or repeatedly for specific periods of time, for example 10 minutes, 20 minutes, 30 minutes, 40 minutes, 50 minutes, or 60 minutes, wherein the duration and intensity of the electrochemical treatment can be adapted to the degree of soiling of the laundry. The bleaching-active species can also be generated by the fact that, in particular when a conventional flushing apparatus is used, the mediator compound passes through an electrochemical cell before admission into the chamber of a washing machine, in particular flows in aqueous solution or as a slurry through an electrochemical cell. The electrochemical cell can be mounted in the inflow conduit inside or outside the machine. Alternatively, it is also possible to allow other active agents, for example enzymes, to perform their function in uninfluenced fashion at the beginning of the method, and only later to start the bleaching action by switching on the electrical voltage for the electrochemical cell.

In a preferred embodiment of the invention, the electrochemical cell is installed inside a washing machine in the water-filled region of the washing or cleaning space, in the case of a drum-type washing machine preferably outside the washing drum. The apparatus can be a permanently installed part of the washing machine, or a separate component. The electrochemical cell is embodied in a further embodiment of the invention as an apparatus separate from a washing machine, which apparatus is operated with an independent power source, for example a battery (e-bleach ball). A further embodiment according to the invention lies in incorporating the electrochemical cell into an additional water circuit inside or outside the machine. In all embodiments it is important that the electrodes of the electrochemical cell can come into contact with the electrolyte (the washing or cleaning liquid, or the service water supplied), which contains the mediator compound, for example when the e-bleach ball is located in the washing drum of a washing machine during the washing process.

It is particularly advantageous here that the activity of the bleach can be easily modified by regulating the current intensity, if desired depending on a degree of soiling or a fabric. In textile washing processes according to the invention there is thus no damage to the textile thereby treated beyond that which occurs when conventional market agents are employed.

Within the scope of the use and the method according to the invention it is preferred if the concentration of the mediator compound in the aqueous washing or cleaning liquid is 0.05 mmol/L to 10 mmol/L, in particular 0.1 mmol/L to 2 mmol/L. The use and the method according to the invention are each preferably carried out at temperatures in the range of from 10° C. to 95° C., in particular 20° C. to 40° C. The use and the method according to the invention are each preferably carried out at pH values in the range of from pH 2 to pH 12, in particular from pH 4 to pH 11.

The use according to the invention or the method according to the invention can be realized particularly easily by employing a washing agent that contains the mediator compound. Washing agents for cleaning textiles and, among these, preferably agents for machine use which contain a mediator compound, in particular in the form of optionally anionically substituted 1-hydroxy-2,2,6,6-tetramethylpiperidine, 2,2,6,6-tetramethylpiperidine N-oxide, or (2,2,6,6-tetramethylpiperidin-1-yl)oxyl, alongside conventional ingredients compatible therewith, in particular based on a surfactant, are therefore preferably used within the scope of the invention. Although the success according to the invention is already established by the electrochemical generation of the bleaching-active species, a corresponding washing agent can also additionally contain in particular peroxygen-containing bleaching agents. It is particularly advantageous, however, that both bleaching agent and conventional bleach activator can be omitted, the result being that a smaller quantity of washing or cleaning agent needs to be used for each washing cycle. In a preferred embodiment, an agent used in accordance with the invention is therefore free of bleaching agent and conventional bleach activator.

The washing liquid is generally a washing liquor in which a washing agent is dissolved in water. Depending on requirements, further components can be mixed with this washing liquor. In certain applications, pure water or other suitable liquids can also be used. Constituents of commercially available washing agents are well known to a person skilled in the art.

Preferably 0.05% by weight to 10% by weight, particularly 0.1% by weight to 5% by weight of the mediator compound is contained in the washing agents. With use of a corresponding washing agent, the cleaning-intensifying effect of the mediator compound can be switched off if desired by complete omission of the electrochemical treatment, for example if this is to be omitted in the case of laundry that is only slightly soiled or in the case of textiles highly sensitive to bleach. The consumer therefore needs only a single washing agent for washing insensitive (generally white) and sensitive (generally colored) textiles.

The washing agents, which can be present as in particular powdered solids, in recompressed particle form, or as homogeneous solutions or suspensions, can in principle contain, in addition to the mediator compound to be used, all known ingredients that are usual in such agents. The washing agents can contain in particular builder substances, surface-active surfactants, water-miscible organic solvents, enzymes, sequestering agents, electrolytes, pH regulators, polymers having special effects, such as soil release polymers, color-transfer inhibitors, anti-graying agents, crease-reducing polymeric active agents and shape-retaining polymeric active agents, bleaching agents, bleach activators, and further adjuvants such as optical brighteners, foam regulators, dyes, and scents.

The washing agents for use in the washing liquid according to the invention can contain one or more surfactants, wherein anionic surfactants, non-ionic surfactants, and mixtures thereof are appropriate in particular, but cationic surfactants and/or amphoteric surfactants can also be contained. Suitable non-ionic surfactants are, in particular, alkyl glycosides and ethoxylation and/or propoxylation products of alkyl glycosides or linear or branched alcohols each having 12 to 18 C atoms in the alkyl portion and 3 to 20, preferably 4 to 10, alkyl ether groups. Corresponding ethoxylation and/or propoxylation products of N-alkylamines, vicinal diols, fatty acid esters and fatty acid amides that correspond, in terms of the alkyl portion, to the aforesaid long-chain alcohol derivatives, and of alkylphenols having 5 to 12 C atoms in the alkyl group can also be used.

Suitable anionic surfactants are, in particular, soaps, and those containing sulfate or sulfonate groups having preferably alkali ions as cations. Usable soaps are preferably the alkali salts of saturated or unsaturated fatty acids having 12 to 18 C atoms. Such fatty acids can also be used in incompletely neutralized form. Included among the usable surfactants of the sulfate type are the salts of sulfuric acid semiesters of fatty alcohols having 12 to 18 C atoms, and sulfurization products of the aforesaid non-ionic surfactants having a low degree of ethoxylation. Included among the usable surfactants of the sulfonate type are linear alkylbenzene sulfonates having 9 to 14 C atoms in the alkyl portion, alkanesulfonates having 12 to 18 C atoms, and olefin sulfonates having 12 to 18 C atoms that are produced upon reaction of corresponding monoolefins with sulfur trioxide, as well as alpha-sulfofatty acid esters that are produced upon sulfonation of fatty acid methyl or ethyl esters.

Surfactants of this kind are contained in the washing agents in quantitative proportions of from preferably 5% by weight to 50% by weight, in particular from 8% by weight to 30% by weight, while the disinfectants according to the invention, as well as cleaning agents according to the invention, preferably contain 0.1% by weight to 20% by weight, in particular 0.2% by weight to 5% by weight of surfactants.

The washing agents, especially when they are ones provided for the treatment of textiles, can contain as cationic active substances having a textile-softening effect, in particular, one or more of the cationic textile-softening substances of the general formulas X, XI, or XII:

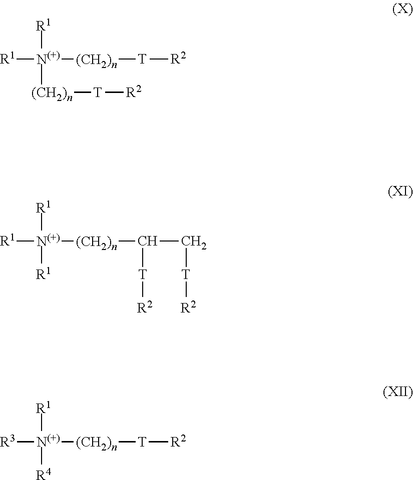

in which each group R¹ is selected independently of one another from C₁₋₆ alkyl, alkenyl, or hydroxyalkyl groups; each group R² is selected independently of one another from C₈₋₂₈ alkyl or alkenyl groups; R³=R¹ or (CH₂)ₙ-T-R²; R⁴=R¹ or R² or (CH₂)ₙ-T-R²; T=—CH₂—, —O—, —CO—, or —CO—O—, and n is an integer from 0 to 5. The cationic surfactants comprise usual anions of a kind and number necessary for charge compensation, wherein these can be selected not only from, for example, halides but also from anionic surfactants. In preferred embodiments of the present invention, hydroxyalkyl trialkyl ammonium compounds, in particular C₁₂₋₁₈ alkyl(hydroxyethyl)dimethyl ammonium compounds, and preferably halides thereof, in particular chlorides, are used as cationic surfactants. An agent according to the invention preferably contains 0.5% by weight, to 25% by weight, in particular 1% by weight to 15% by weight of cationic surfactant.

A washing agent preferably contains at least one water-soluble and/or water-insoluble, organic and/or inorganic builder. Included among the water-soluble organic builder substances are polycarboxylic acids, in particular citric acid and sugar acids, monomeric and polymeric aminopolycarboxylic acids, in particular methylglycinediacetic acid, nitrilotriacetic acid, and ethylenediaminetetraacetic acid, as well as polyaspartic acid, polyphosphonic acids, in particular aminotris(methylenephosphonic acid), ethylenediaminetetrakis(methylenephosphonic acid), and 1-hydroxyethane-1, 1-diphosphonic acid, polymeric hydroxy compounds such as dextrin, as well as polymeric (poly)carboxylic acids, in particular polycarboxylates accessible by the oxidation of polysaccharides or dextrins, and/or polymeric acrylic acids, methacrylic acids, maleic acids, and mixed polymers thereof, which can also contain, polymerized into them, small proportions of polymerizable substances having no carboxylic-acid functionality. The relative molecular mass of the homopolymers of unsaturated carboxylic acids is generally between 5,000 and 200,000, that of the copolymers between 2,000 and 200,000, preferably 50,000 to 120,000, based in each case on free acid. A particularly preferred acrylic acid/maleic acid copolymer has a relative molecular mass from 50,000 to 100,000. Suitable (although less preferred) compounds of this class are copolymers of acrylic acid or methacrylic acid with vinyl ethers, such as vinyl methyl ethers, vinyl esters, ethylene, propylene, and styrene, in which the proportion of acid is equal to at least 50% by weight. It is also possible to use, as water-soluble organic builder substances, terpolymers that contain two unsaturated acids and/or salts thereof as monomers and, as a third monomer, vinyl alcohol and/or an esterified vinyl alcohol or a carbohydrate. The first acid monomer or salt thereof is derived from a monoethylenically unsaturated C₃-C₈ carboxylic acid and preferably from a C₃-C₄ monocarboxylic acid, in particular from (meth)acrylic acid. The second acid monomer or salt thereof can be a derivative of a C₄-C₈ dicarboxylic acid, maleic acid being particularly preferred, and/or a derivative of an allylsulfonic acid that is substituted in the 2-position with an alkyl or aryl group. Such polymers generally have a relative molecular mass between 1,000 g/mol and 200,000 g/mol. Further preferred copolymers are those that comprise, as monomers, acrolein and acrylic acid/acrylic acid salts, or vinyl acetate. Especially for the manufacture of liquid agents, the organic builder substances can be used in the form of aqueous solutions, preferably in the form of 30- to 50-weight-percent aqueous solutions. All the aforesaid acids are used as a rule in the form of their water-soluble salts, in particular their alkali salts.

Organic builder substances of this kind can be contained, if desired, in quantities of up to 40% by weight, in particular up to 25% by weight, and preferably from 1% by weight to 8% by weight. Quantities close to the aforesaid upper limit are used preferably in pasty or liquid, in particular water-containing, agents according to the invention.

Suitable water-soluble inorganic builder materials are, in particular, polymeric alkali phosphates, which can be present in the form of their alkaline, neutral, or acidic sodium or potassium salts. Examples thereof are tetrasodium diphosphate, disodium dihydrogen diphosphate, pentasodium triphosphate, what are known as sodium hexametaphosphate, and the corresponding potassium salts or mixtures of sodium and potassium salts. Crystalline or amorphous alkali aluminosilicates are used in particular as water-insoluble, water-dispersible inorganic builder materials, in quantities of up to 50% by weight, preferably not above 40% by weight, and in liquid agents in particular from 1% by weight to 5% by weight. Among these, the crystalline sodium aluminosilicates of washing-agent quality, in particular zeolite A, P, and optionally X, are preferred. Quantities close to the aforesaid upper limit are used preferably in solid, particulate agents. Suitable aluminosilicates exhibit, in particular, no particles having a particle size greater than 30 μm, and preferably consist of at least 80% by weight particles having a size less than 10 μm. Their calcium binding capability, which can be determined as indicated in German patent DE 2412837, is generally in the range from 100 to 200 mg CaO per gram.

Suitable substitutes or partial substitutes for the aforesaid aluminosilicate are crystalline alkali silicates, which can be present alone or mixed with amorphous silicates. The alkali silicates usable in the agents according to the invention as builders have preferably a molar ratio of alkali oxide to SiO₂ below 0.95, in particular from 1:1.1 to 1:12, and can be present in amorphous or crystalline form. Preferred alkali silicates are the sodium silicates, in particular the amorphous sodium silicates, having a Na₂O: SiO₂ molar ratio from 1:2 to 1:2.8. Crystalline sheet silicates of the general formula Na₂SiₓO₂ₓ₊₁.y H₂O, in which x, the so-called modulus, is a number from 1.9 to 4 and y is a number from 0 to 20, and preferred values for x are 2, 3, or 4, are preferred for use as crystalline silicates, which can be present alone or in a mixture with amorphous silicates. Preferred crystalline sheet silicates are those in which x in the general formula specified assumes the values 2 or 3. In particular, both β- and δ-sodium disilicates (Na₂Si₂O₅.y H₂O) are preferred. Practically anhydrous crystalline alkali silicates manufactured from amorphous alkali silicates and having the aforesaid general formula, in which x denotes a number from 1.9 to 2.1, can also be used in agents according to the invention. In a further preferred embodiment of agents according to the invention, a crystalline sodium sheet silicate having a modulus from 2 to 3 can be used, such as the one that can be manufactured from sand and soda. Crystalline sodium silicates having a modulus in the range from 1.9 to 3.5 are used in a further preferred embodiment of agents according to the invention. In a preferred embodiment of agents according to the invention, a granular compound of alkali silicate and alkali carbonate is used, such as the one commercially obtainable for example under the name Nabion® 15. If alkali aluminosilicate, in particular zeolite, is also present as an additional builder substance, the weight ratio of aluminosilicate to silicate, based in each case on anhydrous active substances, is preferably 1:10 to 10:1. In agents that contain both amorphous and crystalline alkali silicates, the weight ratio of amorphous alkali silicate to crystalline alkali silicate is preferably 1:2 to 2:1, and in particular 1:1 to 2:1.

Builder substances are contained in the washing agents preferably in quantities of up to 60% by weight, in particular from 5% by weight to 40% by weight.

In a preferred embodiment of the invention, a washing agent comprises a water-soluble builder block. The use of the term “builder block” here is intended to express the fact that the agents contain no builder substances other than those that are water-soluble, i.e. all the builder substances contained in the agent are combined in the “block” thus characterized, wherein an exception is made, at most, for substances that may be contained in commercially usual fashion in small quantities, as contaminants or as stabilizing additives, in the other ingredients of the agents. The term “water-soluble” is to be understood in this context to mean that the builder block dissolves without residue, under usual conditions, at the concentration resulting from the utilization quantity of the agent containing it. Preferably at least 15% by weight and up to 55% by weight, in particular 25% by weight to 50% by weight, water-soluble builder block is contained in the agents according to the invention. This is preferably made up of the following components:

a) 5% by weight to 35% by weight citric acid, alkali citrate, and/or alkali carbonate, which can also be replaced at least in part by alkali hydrogen carbonate;
b) up to 10% by weight alkali silicate having a modulus in the range from 1.8 to 2.5;
c) up to 2% by weight phosphonic acid and/or alkali phosphonate;
d) up to 50% by weight alkali phosphate; and
e) up to 10% by weight polymeric polycarboxylate,
wherein the quantitative indications refer to the total washing agent. This also applies to all quantitative indications hereinafter unless expressly indicated otherwise.

In a preferred embodiment of the washing agents these contain the water-soluble builder block with at least two of components b), c), d), and e) in quantities greater than 0% by weight.

With regard to component a), 15% by weight to 25% by weight alkali carbonate, which can be replaced at least in part by alkali hydrogen carbonate, and up to 5% by weight, in particular 0.5% by weight to 2.5% by weight citric acid and/or alkali citrate, are contained in a preferred embodiment of the washing agents. In an alternative embodiment of the washing agents, 5% by weight to 25% by weight, in particular 5% by weight to 15% by weight citric acid and/or alkali citrate and up to 5% by weight, in particular 1% by weight to 5% by weight alkali carbonate, which can be replaced at least in part by alkali hydrogen carbonate, are contained as component a). If both alkali carbonate and alkali hydrogen carbonate are present, component a) comprises alkali carbonate and alkali hydrogen carbonate preferably at a weight ratio from 10:1 to 1:1.

With regard to component b), 1% by weight to 5% by weight alkali silicate having a modulus in the range from 1.8 to 2.5 is contained in a preferred embodiment of the washing agents.

With regard to component c), 0.05% by weight to 1% by weight phosphonic acid and/or alkali phosphonate is contained in a preferred embodiment of the washing agents. “Phosphonic acids” are also understood in this context as optionally substituted alkylphosphonic acids that can also comprise several phosphonic-acid groupings (so-called polyphosphonic acids). They are preferably selected from the hydroxy- and/or aminoalkylphosphonic acids and/or alkali salts thereof, such as dimethylaminomethanediphosphonic acid, 3-aminopropane-1-hydroxy-1, 1-diphosphonic acid, 1-amino-1-phenylmethanediphosphonic acid, 1-hydroxyethane-1, 1-diphosphonic acid, amino-tris(methylenephosphonic acid), N,N,N′,N′-ethylenediaminetetrakis(methylenephosphonic) acid, and acylated derivatives of phosphoric acid, which can also be used in any mixtures.

With regard to component d), 15% by weight to 35% by weight alkali phosphate, in particular trisodium polyphosphate, is contained in a preferred embodiment of the washing agents. “Alkali phosphate” is the collective term for the alkali-metal (in particular sodium and potassium) salts of the various phosphoric acids, in which context a distinction can be made between metaphosphoric acids (HPO₃)n and orthophosphoric acid H₃PO₄, in addition to higher-molecular-weight representatives. The phosphates embody a number of advantages: they act as alkali carriers, prevent lime deposits on machine parts and lime encrustations in fabrics, and furthermore contribute to cleaning performance. Sodium dihydrogen phosphate, NaH₂PO₄, exists as the dihydrate (density 1.91 gcm⁻³, melting point) 60° and as the monohydrate (density 2.04 gcm⁻³). Both salts are white powders, very easily soluble in water, that lose their water of crystallization upon heating and transition at 200° C. into the weakly acidic diphosphate (disodium hydrogendiphosphate, Na₂H₂P₂O₇), and at higher temperature into sodium trimetaphosphate (Na₃P₃O₉) and Maddrell's salt. NaH₂PO₄ reacts in acidic fashion; it is created when phosphoric acid is adjusted with sodium hydroxide to a pH of 4.5 and the mash is spray-dried. Potassium dihydrogen phosphate (primary or monobasic potassium phosphate, potassium diphosphate, KDP), KH₂PO₄, is a white salt of density 2.33 gcm⁻³, has a melting point of 253° (decomposing to form (KPO₃)ₓ, potassium polyphosphate), and is easily soluble in water. Disodium hydrogen phosphate (secondary sodium phosphate), Na₂HPO₄, is a colorless, very easily water-soluble crystalline salt. It exists anyhdrously and with 2 mol (density 2.066 gcm⁻³, loss of water at 95°), 7 mol (density 1.68 gcm⁻³, melting point 48° with loss of 5 H₂O), and 12 mol of water (density 1.52 gcm⁻³, melting point 35° with loss of 5 H₂O); it becomes anhydrous at 100°, and when further heated transitions into the diphosphate Na₄P₂O₇. Disodium hydrogen phosphate is produced by neutralizing phosphoric acid with a soda solution using phenolphthalein as indicator. Dipotassium hydrogen phosphate (secondary or dibasic potassium phosphate), K₂HPO₄, is an amorphous white salt that is easily soluble in water. Trisodium phosphate (tertiary sodium phosphate), Na₃PO₄, exists as colorless crystals that as the dodecahydrate have a density of 1.62 gcm⁻³ and a melting point of 73 to 76° C. (decomposition), as the decahydrate (corresponding to 19 to 20% P₂O₅) a melting point of 100° C., and in anhydrous form (corresponding to 39 to 40% P₂O₅) a density of 2.536 gcm⁻³. Trisodium phosphate is easily soluble in water with an alkaline reaction, and is produced by evaporating a solution of exactly 1 mol disodium phosphate and 1 mol NaOH. Tripotassium phosphate (tertiary or tribasic potassium phosphate), K₃PO₄, is a white, deliquescent, granular powder with a density of 2.56 gcm⁻³, has a melting point of 1340° C., and is easily soluble in water with an alkaline reaction. It is produced, for example, upon heating of basic slag with carbon and potassium sulfate. Despite the higher price, the more easily soluble and therefore highly active potassium phosphates are greatly preferred over corresponding sodium compounds in the cleaning-agent industry. Tetrasodium diphosphate (sodium pyrophosphate), Na₄P₂O₇, exists in anhydrous form (density 2.534 gcm⁻³, melting point 988°, also specified 880°) and as the decahydrate (density 1.815 to 1.836 gcm⁻³, melting point 94° with loss of water). Both substances are colorless crystals that are soluble in water with an alkaline reaction. Na₄P₂O₇ is created when disodium phosphate is heated to >200°, or by reacting phosphoric acid with soda at the stoichiometric ratio and dewatering the solution by spraying. The decahydrate complexes heavy-metal salts and hardness constituents, and therefore decreases the water hardness. Potassium diphosphate (potassium pyrophosphate), K₄P₂O₇, exists in the form of the trihydrate and represents a colorless, hygroscopic powder with a density of 2.33 gcm⁻³ that is soluble in water, the pH of a 1% solution being 10.4 at 25°. Condensation of NaH₂PO₄ or KH₂PO₄ yields higher-molecular-weight sodium and potassium phosphates, within which a distinction can be made between cyclic representatives (the sodium or potassium metaphosphates) and chain types (the sodium or potassium polyphosphates). For the latter in particular, a number of designations are in use: fused or thermal phosphates, Graham salt, Kurrol's salt, and Maddrell's salt. All the higher sodium and potassium phosphates are together referred to as “condensed” phosphates. The industrially important pentasodium triphosphate Na₅P₃O₁₀ (sodium tripolyphosphate) is a white, water-soluble, non-hygroscopic salt, crystallizing anhydrously or with 6 H₂O, of the general formula NaO—[P(O)(ONa)—O]ₙ—Na, where n=3. Approximately 17 g of the salt containing no water of crystallization dissolves in 100 g of water at room temperature, approximately 20 g at 60° C., and approximately 32 g at 100°; after the solution is heated to 100° for two hours, approximately 8% orthophosphate and 15% disphosphate are produced by hydrolysis. In the production of pentasodium triphosphate, phosphoric acid is reacted with a soda solution or sodium hydroxide at the stoichiometric ratio, and the solution is dewatered by spraying. Like Graham salt and sodium diphosphate, pentasodium triphosphate dissolves many insoluble metal compounds (including lime soaps). Pentapotassium triphosphate K₅P₃O₁₀ (potassium tripolyphosphate) is marketed, for example, in the form of a 50% by weight solution (>23% P₂O₅, 25% K₂O). Potassium polyphosphates are widely used in the washing- and cleaning-agent industry. Sodium potassium tripolyphosphates also exist and are likewise usable in the context of the present invention. They are produced, for example, when sodium trimetaphosphate is hydrolyzed with KOH:

(NaPO₃)₃+2KOH→Na₃K₂P₃O₁₀+H₂O

These are usable in just the same way as sodium tripolyphosphate, potassium tripolyphosphate, or mixtures of the two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate are also usable in accordance with the invention.

With regard to component e), 1.5% by weight to 5% by weight polymeric polycarboxylate, selected in particular from the polymerization products or copolymerization products of acrylic acid, methacrylic acid, and/or maleic acid, are contained in a preferred embodiment of the washing agents. Among these, the homopolymers of acrylic acid, and among the latter those having an average molar mass in the range from 5,000 D to 15,000 D (PA standard), are particularly preferred.

Enzymes usable in the agents are those from the class of the proteases, lipases, cutinases, amylases, pullulanases, mannanases, cellulases, hemicellulases, xylanases, oxidases, and peroxidases, as well as mixtures thereof, for example proteases such as BLAP®, Optimase®, Opticlean®, Maxacal®, Maxapem®, Alcalase®, Esperase®, Savinase®, Durazym® and/or Purafect® OxP, amylases such as Termamyl®, Amylase-LT®, Maxamyl®, Duramyl® and/or Purafect® OxAm, lipases such as Lipolase®, Lipomax®, Lumafast® and/or Lipozym®, cellulases such as Celluzyme® and/or Carezyme®. Enzymatic active agents recovered from fungi or bacteria, such as Bacillus subtilis, Bacillus licheniformis, Streptomyces griseus, Humicola lanuginosa, Humicola insolens, Pseudomonas pseudoalcaligenes, or Pseudomonas cepacia, are particularly suitable. The enzymes that are optionally used can be adsorbed onto carrier substances and/or embedded into encasing substances in order to protect them from premature inactivation. They are contained in the washing, cleaning, and disinfecting agents according to the invention preferably in quantities of up to 10% by weight, in particular from 0.2% by weight to 2% by weight, wherein enzymes stabilized against oxidative breakdown are used with particular preference.

In a preferred embodiment of the invention, the agent contains 5% by weight to 50% by weight, in particular 8 to 30% by weight anionic and/or non-ionic surfactant, up to 60% by weight, in particular 5 to 40% by weight builder substance, and 0.2% by weight to 2% by weight enzyme, selected from the proteases, lipases, cutinases, amylases, pullulanases, mannanases, cellulases, oxidases, and peroxidases as well as mixtures thereof.

Appropriate peroxygen compounds optionally contained in the agents, which nevertheless can preferably be omitted from agents provided for use in methods according to the invention, are in particular organic peracids or peracid salts of organic acids, such as phthalimidopercaproic acid, perbenzoic acid, or salts of diperdodecanedioic acid, hydrogen peroxide, and inorganic salts that release hydrogen peroxide under washing conditions, such as perborate, percarbonate, and/or persilicate. Hydrogen peroxide can also be generated with the aid of an enzymatic system, i.e. an oxidase and its substrate. If solid peroxygen compounds are to be employed, they can be utilized in the form of powders or granulates, which can also in principle be encased in the known manner. It is particularly preferred to employ alkali percarbonate, alkali perborate monohydrate, alkali perborate tetrahydrate, or hydrogen peroxide in the form of aqueous solutions that contain 3% by weight to 10% by weight hydrogen peroxide. If desired, peroxygen compounds are present in the washing agents in quantities of up to 50% by weight, in particular from 5% by weight to 30% by weight.

Usual bleach activators that form peroxocarboxylic acids or peroxoimidic acids under perhydrolysis conditions, and/or usual transition metal complexes that activate bleaches, can additionally be used. The bleach activator component that is optionally present, in particular in quantities from 0.5% by weight to 6% by weight, comprises the N- or O-acyl compounds that are usually used, for example polyacylated alkylenediamines, in particular tetraacetylethylenediamine, acylated glycourils, in particular tetraacetylglycouril, N-acylated hydantoins, hydrazides, triazoles, urazoles, diketopiperazines, sulfurylamides, and cyanurates, also carboxylic acid anhydrides, in particular phthalic acid anhydride, carboxylic acid esters, in particular sodium isononanoyl phenolsulfonate, and acylated sugar derivatives, in particular pentaacetyl glucose, as well as cationic nitrile derivatives such as trimethylammonium acetonitrile salts. In order to avoid interaction with the per-compounds during storage, the bleach activators can be granulated or coated with encasing substances in the known manner, wherein tetraacetylethylenediamine granulated with the aid of carboxymethyl cellulose and having average particles sizes from 0.01 mm to 0.8 mm, granulated 1,5-diacetyl-2,4-dioxohexahydro-1,3,5-triazine, and/or trialkylammonium acetonitrile formulated in particle form are particularly preferred. Bleach activators of this kind are contained in washing or cleaning agents preferably in quantities of up to 8% by weight, in particular from 2% by weight to 6% by weight, based in each case on the total agent.

Included among the organic solvents usable in the agents, especially when the latter are present in liquid or pasty form, are alcohols having 1 to 4 C atoms, in particular methanol, ethanol, isopropanol, and tert-butanol, diols having 2 to 4 C atoms, in particular ethylene glycol and propylene glycol, as well as mixtures thereof, and the ethers derivable from the aforesaid compound classes. Water-miscible solvents of this kind are present in the washing agents according to the invention preferably in quantities not above 30% by weight, in particular from 6% by weight to 20% by weight.

In order to establish a desired pH that does not result of itself from mixture of the other components, the agents according to the invention can contain system-compatible and environmentally compatible acids, in particular citric acid, acetic acid, tartaric acid, malic acid, lactic acid, glycolic acid, succinic acid, glutaric acid, and/or adipic acid, but also mineral acids, in particular sulfuric acid, or bases, in particular ammonium hydroxides or alkali hydroxides. pH regulators of this kind are contained in the agents according to the invention in quantities preferably not above 20% by weight, in particular from 1.2% by weight to 17% by weight.

Soil-release-enabling polymers, which are often referred to as “soil release” active agents, or as “soil repellents” because of their ability to make the treated surface (for example of the fibers) soil-repellent, are, for example, non-ionic or cationic cellulose derivatives. Included among the, in particular, polyester-active soil-release-enabling polymers are copolyesters of dicarboxylic acids, for example adipic acid, phthalic acid or terephthalic acid, diols, for example ethylene glycol or propylene glycol, and polydiols, for example polyethylene glycol or polypropylene glycol. Included among the soil-release-enabling polyesters preferred for use are those compounds that are accessible formally by esterification of two monomer parts, the first monomer being a dicarboxylic acid HOOC-Ph-COOH and the second monomer being a diol HO—(CHR¹¹—)ₐOH, which can also be present as a polymeric diol H—(O—(CHR¹¹—)ₐ)_{b}OH, in which Ph denotes an o-, m-, or p-phenylene group that can carry 1 to 4 substituents selected from alkyl groups having 1 to 22 carbon atoms, sulfonic acid groups, carboxyl groups, and mixtures thereof, R¹¹ denotes hydrogen, an alkyl group having 1 to 22 C atoms, and mixtures thereof, a is a number from 2 to 6, and b is a number from 1 to 300. Preferably, both monomer diol units —O—(CHR¹¹—)ₐO— and polymer diol units —(O—(CHR¹¹—)ₐ)_{b}O— are present in the polyesters obtainable therefrom. The molar ratio of monomer diol units to polymer diol units is preferably 100:1 to 1:100, in particular 10:1 to 1:10. In the polymer diol units, the degree of polymerization b is preferably in the range from 4 to 200, in particular from 12 to 140. The molecular mass or average molecular mass, or the maximum of the molecular mass distribution, of preferred soil-release-enabling polyesters is in the range from 250 to 100,000, in particular from 500 to 50,000. The acid on which the group Ph is based is selected preferably from terephthalic acid, isophthalic acid, phthalic acid, trimellitic acid, mellitic acid, the isomers of sulfophthalic acid, sulfoisophthalic acid, and sulfoterephthalic acid, and mixtures thereof. If their acid groups are not part of the ester bonds in the polymer, they are preferably present in salt form, in particular as an alkali or ammonium salt. Among these, the sodium and potassium salts are particularly preferred. If desired, instead of the HOOC-Ph-COOH monomer, small proportions—in particular no more than 10 mol % based on the proportion of Ph having the meaning indicated above—of other acids that comprise at least two carboxyl groups can be contained in the soil-release-enabling polyester. Included among these are, for example, alkylene and alkenylene dicarboxylic acids such as malonic acid, succinic acid, fumaric acid, maleic acid, glutaric acid, adipic acid, pimelic acid, suberic acid, azelaic acid, and sebacic acid. Examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol, and neopentyl glycol. Polyethylene glycol having an average molar weight in the range from 1000 to 6000 is particularly preferred among the polymeric diols. If desired, these polyesters can also be end-capped, wherein alkyl groups having 1 to 22 C atoms and esters of monocarboxylic acids are suitable as terminal groups. It is preferred to use, alone or in combination with the cellulose derivatives, polymers of ethylene terephthalate and polyethylene oxide terephthalate in which the polyethylene glycol units have molecular mass from 750 to 5000 and the molar ratio of ethylene terephthalate to polyethylene oxide terephthalate is 50:50 to 90:10.

Conventional color transfer inhibitors that are suitable for use in the agents for laundering textiles include, in particular, polyvinylpyrrolidones, polyvinylimidazoles, polymeric N-oxides such as poly(vinylpyridine-N-oxide), and copolymers of vinylpyrrolidone with vinylimidazole and, if appropriate, further monomers.

Because textile fabrics, in particular those made of rayon, wool, cotton, and mixtures thereof, can tend to wrinkle because the individual fibers are sensitive to bending, kinking, compression, and squeezing perpendicularly to the fiber direction, the agents for use in textile laundering can contain crease-prevention agents. These include, for example, synthetic products based on fatty acids, fatty acid esters, fatty acid amides, fatty acid alkylol esters, fatty acid alkylolamides, or fatty alcohols that are usually reacted with ethylene oxide, or products based on lecithin or modified phosphoric acid esters.

The purpose of anti-graying agents is to keep dirt that has been detached from the hard surface, and in particular from the textile fibers, suspended in the liquid. Water-soluble colloids, usually organic in nature, are suitable for this, for example starch, size, gelatin, salts of ethercarboxylic or ethersulfonic acids of starch or of cellulose, or salts of acidic sulfuric-acid esters of cellulose or of starch. Water-soluble polyamides containing acid groups are also suitable for this purpose. Starch derivatives other than those specified above can also be used, for example aldehyde starches. Cellulose ethers such as carboxymethyl cellulose (sodium salt), methyl cellulose, hydroxyalkyl cellulose, and mixed ethers such as methylhydroxyethyl cellulose, methylhydroxypropyl cellulose, methylcarboxymethyl cellulose, and mixtures thereof are preferably used, for example in quantities from 0.1 to 5% by weight based on the agent.

The agents can contain optical brighteners, among them in particular derivatives of diaminostilbenedisulfonic acid or alkali metal salts thereof. Suitable, for example, are salts of 4,4′-bis(2-anilino-4-morpholino-1,3,5-triazinyl-6-amino)stilbene-2,2′-disulfonic acid, or compounds of similar structure that carry a diethanolamino group, a methylamino group, an anilino group, or a 2-methoxyethylamino group instead of the morpholino group. Brighteners of the substituted diphenylstyryl type can also be present, for example the alkali salts of 4,4′-bis(2-sulfostyryl)diphenyl, of 4,4′-bis(4-chloro-3-sulfostyryl)diphenyl, or of 4-(4-chlorostyryl)-4′-(2-sulfostyryl)diphenyl. Mixtures of the aforesaid brighteners can also be used.

Active agents to prevent the tarnishing of objects made of silver, or what are known as silver corrosion inhibitors, can additionally be employed in the washing agents. Preferred silver corrosion protection agents are organic disulfides, divalent phenols, trivalent phenols, optionally alkyl- or aminoalkyl-substituted triazoles such as benzotriazole, and salts and/or complexes of cobalt, manganese, titanium, zirconium, hafnium, vanadium, or cerium in which the aforesaid metals are present in one of the oxidation states II, III, IV, V, or VI.

The manufacture of the solid agents presents no difficulties, and can be accomplished in a manner known in principle, for example by spray drying or granulation. A method comprising an extrusion step is preferred for the manufacture of agents having an elevated bulk weight, in particular in the range from 650 g/L to 950 g/L. Washing agents in the form of solutions containing aqueous or other usual solvents are manufactured particularly advantageously by simply mixing the ingredients, which can be introduced as substance or in solution into an automatic mixer.

A key aspect of the present invention comprises a method for cleaning a soiled textile substrate, wherein the method includes the treatment of the moist substrate with a formulation comprising a multiplicity of water-insoluble solid particles, in which the particles are optionally re-used in further cleaning processes according to the method after a regeneration with or without use of a washing agent.

The substrate comprises textile substrates, each optionally formed form a multiplicity of materials, which can be either a natural fiber, such as cotton, or synthetic textile fibers, for example nylon 6,6 or a polyester.

The water-insoluble solid particles can be inorganic and/or organic in nature. By way of example, zeolites, clays or ceramic are particularly preferred when it comes to the solid particles. The particles can have a certain hydrophilicity in order to enable a wetting with the washing liquid.

The organic water-insoluble solid particles can comprise any multiplicity of different polymers. Polyalkenes such as polyethylene and polypropylene, polyesters and polyurethanes are particularly preferred. However, the polymer particles formed from polyamide are preferred, very preferably particles from nylon, most preferably in the form of nylon chips. The polyamides are particularly effective for the removal of hydrophilic dirt, whereas polyalkenes are particularly useful for the removal of oil-containing stains. Copolymers of the above polymer materials can be used as appropriate for the purposes of the invention.

Various nylon homo- or co-polymers can be used, including nylon 6 and nylon 6,6. The polyamide preferably comprises nylon 6,6 homopolymer having a weight-average molecular mass in a range of from 5,000 to 30,000 daltons, preferably 10,000 to 20,000 daltons, most preferably from 15,000 to 16,000 daltons.

The water-insoluble solid particles or granulate, particles or shaped bodies are of such a shape and size that enables good flowability and close contact with the textile substrate. Preferred shapes of the particles include spheres and cubes, however the preferred particle shape is cylindrical. The particles are preferably dimensioned such that they each have an average weight in the range of 20 to 50 mg, preferably 30 to 40 mg. In the case of the most-preferred cylindrical particles, the preferred average particle diameter is 1.5 to 6.0 mm, particularly preferably 2.0 to 5.0 mm, most preferably 2.5 to 4.5 mm, whereas the length of the cylindrical particles preferably lies in a range of from 2.0 to 6.0 mm, particularly preferably 3.0 to 5.0 mm, and most preferably in the region of 4.0 mm.

Prior to cleaning, the textile substrate is preferably moistened by wetting with water in order to provide an additional improvement for the washing liquid and thus enable an improvement of the transport properties within the system (pre-treatment). A more efficient transfer from the washing agent to the substrate and the removal of dirt and stains from the substrate are thus facilitated. The substrate can be simply wetted most comfortably by contact with mains water. The wetting treatment is preferably carried out in order to achieve a substrate-to-water weight ratio in a range of from 1:0.1 to 1:5; the ratio more preferably lies in a range of from 1:0.2 to 1:2, wherein particularly favorable results are attained with ratios such as 1:0.2, 1:1 and 1:2. However, successful results with substrate-to-water ratios of up to 1:50 can be achieved in some cases, although such ratios are not preferred in view of the significant quantities of wastewater that are produced.

In the method according to this aspect of the invention, which can be referred to as an interstitial method for cleaning or scrubbing, the weight ratio of textile substrate to water-insoluble solid particles is set in a range of from 1:1 to 1:30, in particular from 1:1.5 to 1:2.5, very particularly 1:2. Here, the proportion of the water-insoluble solid particles is determined as weight of the particles in the dry state, i.e. after 24-hour storage at 21° C. and a relative humidity of 65%.

An essential feature of the device according to the invention is the presence of the electrochemical cell, which is preferably integrated in the device, the above-mentioned water-insoluble solid particles, and a reservoir for the particles.

The device according to the invention typically has a hinged door in a housing in order to enable access to the interior of the washing drum so as to provide a substantially closed system. The door preferably closes a window of the stationary cylindrical drum, which is rotatably mounted in a further drum, whereas the rotatably mounted cylinder drum is mounted vertically within the housing. Consequently, a front-loading device is preferred. Alternatively, the stationary cylindrical drum can be mounted vertically within the housing and the access device is disposed in the upper side of the device.

The device is suitable for providing contact between the particles and the soiled substrate. Ideally, these particles should be effectively circulated in order to promote effective cleaning.

In accordance with the invention the device comprises at least one reservoir, in particular having a corresponding controller, for the water-insoluble solid particles, which reservoir is disposed for example within the washing machine and can control the flow of the particles within the washing machine and contains the particles for regeneration.

It has also been shown that, by means of the measures of the method according to the invention, the regeneration of the water-insoluble solid particles is possible and the particles can be satisfactorily re-used in the cleaning method, although a certain impairment of the power will be observed, generally after three uses of the particles.

The regeneration of the water-insoluble solid particles can take place in a manner known per se, as is described for example in WO 2012/035342 A1. Within the scope of the present invention, the regeneration is performed by introducing the particles optionally with industrial chemicals and/or the washing agent into the device comprising the electrochemical cell, for example in a separate rinsing cycle, optionally by addition of further cleaning agents, which can also be of an aggressive nature. The temperature of the regeneration step is independent of the washing temperature when the textile substrate has been removed from the washing machine prior to the regeneration. The conventional washing agent raw materials can also be used.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An aqueous washing liquid in a device for cleaning textile substrates comprising a multiplicity of water-insoluble solid particles and at least one mediator compound, wherein the mediator compound can produce an oxidizing bleaching agent in an electrochemical cell using electric voltage in the washing liquid.

2. The washing liquid according to claim 1, wherein the mediator compound is selected from the group consisting of 1-hydroxy-2,2,6,6-tetramethylpiperidine, 2,2,6,6-tetramethylpiperidine N-oxide, (2,2,6,6-tetramethylpiperidin-1-yl)ozyl, and mixtures thereof.

3. The washing liquid according to claim 1, wherein the concentration of the mediator compound in the liquid proportion of the washing liquid is 0.05 mmol/L to 10 mmol/L.

4. The washing liquid according to claim 1, wherein the pH value lies in a range of from pH 2 to pH 12.

5. The washing liquid according to claim 1, wherein it comprises a textile substrate and
a. the weight ratio of substrate to water lies in a range of from 1:0.1 to 1:5 and/or
b. a weight ratio of textile substrate to water-insoluble solid particles lies in a range of from 1:1 to 1:30, in particular from 1:1.5 to 1:2.5.

6. The washing liquid according to claim 1, wherein
a. the water-insoluble solid particles are inorganic in nature, or
b. the water-insoluble solid particles are organic in nature.

7. The washing liquid according to claim 6, wherein the particles comprise organic polymer particles selected from the group consisting of polyester particles, polyurethane particles and polyamide particles.

8. The washing liquid according to claim 1, characterized in that the water-insoluble solid particles are present in the form of spheres, cubes and/or cylinders.

9. The washing liquid according to claim 1, characterized in that the water-insoluble solid particles have an average weight in a range of from 20 to 50 mg.

10. A method for cleaning soiled textile substrates comprising the step of contacting the soiled textile substrate with a washing liquid according to claim 1.

11. The method according to claim 10, wherein the washing liquid containing the mediator compound is electrochemically converted continuously, or once, or repeatedly for certain periods of time.
